(19) United States
(12) Patent Application Publication
(10) Pub. No.: US 2026/0342596 A1
(43) Pub. Date: Oct. 29, 2026

(54) IDENTITY AUTHENTICATION METHOD AND SYSTEM, ISSUANCE METHOD, DEVICE, PLATFORM, AND SERVER

(71) Applicants: Beijing BOE Technology Development Co., Ltd., Beijing (CN); BOE Technology Group Co., Ltd., Beijing (CN)

(72) Inventors: Xitong MA, Beijing (CN); Zhuohua LIU, Beijing (CN); Hongjun DU, Beijing (CN)

(21) Appl. No.: 18/995,265

(22) PCT Filed: May 31, 2023
(86) PCT No.: PCT/CN2023/097410

§ 371 Date: Jan. 16, 2025

(51) Int. Cl. H04L 9/32; H04L 9/06

(52) U.S. Cl. CPC H04L 9/3268; H04L 9/0618

(57) ABSTRACT

Disclosed are an identity authentication method and system, a certificate issuance method, a terminal device, an IoT platform, an authentication server, an electronic device and a computer-readable medium. The method includes: receiving an encrypted certificate and a signed certificate from a terminal device, verifying their validity based on a public key certificate from an authentication server; extracting a first public key from the encrypted certificate, a second public key from the signed certificate if the verification is successful; encrypting a first random number using the first public key to generate a first ciphertext; sending the first ciphertext to the terminal device, the terminal device decrypts the first ciphertext to generate signature data; acquiring decrypted data using the second public key in response to the signature data; matching the first random number with the decrypted data. The identity authentication for the terminal device is successful if the matching is successful.

### FIELD OF THE DISCLOSURE

The present disclosure relates to the field of internet of things (IoT) technology, in particular, to an identity authentication method (a method for authenticating an identity), an identity authentication system (a system for authenticating an identity), a certificate issuance method (a method for issuing a certificate), a terminal device, an internet of things platform (IoT platform), an authentication server, an electronic device and a computer-readable medium.

### BACKGROUND OF THE DISCLOSURE

In recent years, the internet of things technology is rapidly developed, which has profound influence on a basic industry of human society such as an agriculture, an industry, a service industry, and brings profound changes to the production and lifestyle of the society. The internet of things technology realizes the identification, monitoring, positioning, connection, tracking and management of devices by acquiring information from sensors in real time, so that the devices, network and interaction become more intelligent. Along with the rapid increase of the scale of the internet of things, the identity authentication problem of the devices in the internet of things is more and more emphasized.

### SUMMARY OF THE DISCLOSURE

The present disclosure provides an identity authentication method, an identity authentication system, a certificate issuance method, a terminal device, an internet of things platform (IoT platform), an authentication server, an electronic device and a computer-readable medium.

As a first aspect, the present disclosure provides an identity authentication method for an IoT platform, including: receiving an encrypted certificate and a signed certificate sent from a terminal device, and verifying validity of the encrypted certificate and the signed certificate based on a public key certificate sent from an authentication server in advance; extracting a first public key of the terminal device from the encrypted certificate, and extracting a second public key of the authentication server from the signed certificate in response that the verification of the encrypted certificate and the signed certificate is successful; encrypting a first random number based on the first public key to generate a first ciphertext, wherein the first random number is data randomly generated by the IoT platform by using a server cipher machine; sending the first ciphertext to the terminal device, so that the terminal device decrypts the first ciphertext to generate signature data; acquiring decrypted data based on the second public key in response to the signature data; and matching the first random number with the decrypted data, and determining that identity authentication for the terminal device is successful in response to that the first random number is successfully matched with the decrypted data.

In some embodiments, the signature data is generated by the terminal device encryping and signing a decryption result of the first ciphertext based on a fourth public key of the IoT platform and a second private key obtained in advance, wherein the second private key is matched in pair with the second public key; and the decrypted data is generated by verifying and decrypting the signature data based on the second public key and a fourth private key of the IoT platform.

In some embodiments, the signature data is generated by the terminal device signing a second ciphertext with the second private key; the second ciphertext is generated by the terminal device encrypting a second random number based on the fourth public key, and the second random number is data generated by concatenating a decryption result of the first ciphertext with a third random number.

In some embodiments, acquiring the decrypted data based on the second public key in response to the signature data, includes: verifying a signature for the signature data by using the second public key in response to the signature data; and decrypting the second ciphertext obtained by verifying the signature for the signature data based on the fourth private key in response that the verification of the signature data is successful.

In some embodiments, in response to the identity authentication for the terminal device is successful, the method further includes: serving the decrypted data as a negotiation key; encrypting successful authentication message by using the negotiation key to generate an authentication message ciphertext; and sending the authentication message ciphertext to the terminal device.

In some embodiments, verifying the validity of the encrypted certificate and the signed certificate based on the public key certificate sent from the authentication server in advance, includes: acquiring a third public key of the authentication server from a public key certificate sent from the authentication server in advance; verifying the signature for the encrypted certificate with the third public key, and determining that the encrypted certificate is valid in response to that the verification of the encrypted certificate is successful; and verifying the signature for the signed certificate with the third public key, and determining that the signed certificate is valid in response to that the verification of the signed certificate is successful.

In some embodiments, prior to receiving the encrypted certificate and the signed certificate from the terminal device, the method further includes: receiving and storing the public key certificate sent from the authentication server, wherein the public key certificate records therein a third public key matched in pair with the third private key; generating a fourth public key and a fourth private key matched in pair; and sending the fourth public key to the authentication server, so that the authentication server signs the fourth public key by using the third private key to generate a platform certificate.

As a second aspect, the present disclosure provides an identity authentication method for a terminal device, including: submitting an encrypted certificate and a signed certificate to an IoT platform, so that the IoT platform extracts a first public key from the encrypted certificate and extracts a second public key of an authentication server from the signed certificate in response to the encrypted certificate and the signed certificate are valid; receiving a first ciphertext sent from the IoT platform in response that verification of the encrypted certificate and the signed certificate is successful; decrypting the first ciphertext by using a first private key of the terminal device, wherein the first public key is matched in pair with the first private key; generating signature data based on a decryption result of the first ciphertext; and sending the signature data to the IoT platform, so that the IoT platform acquires decrypted data based on the second public key, and authenticates the identity of the terminal device based on the decrypted data.

In some embodiments, generating the signature data based on the decryption result of the first ciphertext, includes: encrypting and signing the decryption result of the first ciphertext based on a fourth public key of the IoT platform and a second private key obtained in advance to generate the signature data, wherein the second public key is matched in pair with the second private key.

In some embodiments, encrypting and signing the decryption result of the first ciphertext based on the fourth public key of the IoT platform and the second private key obtained in advance to generate the signature data, includes: concatenating the decryption result of the first ciphertext with a third random number to generate a second random number; encrypting the second random number by using the fourth public key to generate a second ciphertext; and signing the second ciphertext by using the second private key to generate the signature data.

In some embodiments, the identity authentication method further includes: in response to an authentication message ciphertext sent from the IoT platform, decrypting the authentication message ciphertext by using the second random number as a negotiation key to obtain a successful authentication message.

In some embodiments, prior to submitting the encrypted certificate and the signed certificate to the IoT platform, the method further includes: generating a first public key and a first private key matched in pair; sending the first public key to the authentication server, so that the authentication server signs the first public key by using a third private key to generate the encrypted certificate; receiving and storing the encrypted certificate, the signed certificate and a platform certificate sent from the authentication server, wherein the platform certificate records therein a fourth public key of the IoT platform, and the signed certificate is generated by the authentication server signing the second public key with the third private key; and decrypting, in response to a private key ciphertext sent from the authentication server, the private key ciphertext based on the first private key to obtain and store a second private key.

As a third aspect, the present disclosure provides a certificate issuance method for an authentication server, including: generating a third private key and a public key certificate, wherein the public key certificate records therein a third public key matched in pair with the third private key; signing, in response to a first public key sent from terminal device, the first public key based on the third public key to generate an encrypted certificate, and sending the encrypted certificate to the terminal device; signing a second public key of the authentication server based on the third private key to generate a signed certificate; and sending the signed certificate to the terminal device; and sending the public key certificate to the IoT platform, so that the IoT platform verifies validity of the encrypted certificate and the signed certificate from the terminal device based on the public key certificate.

In some embodiments, the method further includes: encrypting a second private key to generate a private key ciphertext, and sending the private key ciphertext to the terminal device, so that the terminal device decrypts the private key ciphertext to obtain the second private key, wherein the second private key is matched in pair with the second public key.

In some embodiments, the method further includes: signing, in response to a fourth public key sent from the IoT platform, the fourth public key based on the third private key to generate a platform certificate; and sending the platform certificate to the terminal device.

As a fourth aspect, the present disclosure provides an IoT platform, including: a verification module configured to receive an encrypted certificate and a signed certificate sent from a terminal device, and verify validity of the encrypted certificate and the signed certificate based on a public key certificate sent from an authentication server in advance; an extraction module configured to extract a first public key of the terminal device from the encrypted certificate and extract a second public key of the authentication server from the signed certificate in response to the verification of the encrypted certificate and the signed certificate are successful; a first identity authentication module configured to encrypt a first random number based on the first public key to generate a first ciphertext, send the first ciphertext to the terminal device so that the terminal device decrypts the first ciphertext to generate signature data, acquire decrypted data based on the second public key in response to the signature data, match the first random number with the decrypted data, and determine that identity authentication for the terminal device is successful in response to that the first random number is successfully matched with the decrypted data; wherein the first random number is data generated by the IoT platform randomly by using a server cipher machine.

As a fifth aspect, the present disclosure provides a terminal device, including: a sending module configured to submit an encrypted certificate and a signed certificate to an IoT platform, so that the IoT platform extracts a first public key from the encrypted certificate and extracts a second public key of an authentication server from the signed certificate in response that the encrypted certificate and the signed certificate are valid; and a second identity authentication module configured to receive a first ciphertext sent from the IoT platform in response that verification of the encrypted certificate and the signed certificate is successful, decrypt the first ciphertext based on a first private key of the terminal device, generate signature data based on a decryption result of the first ciphertext, and send the signature data to the IoT platform so that the IoT platform obtains decrypted data based on the second public key and authenticates an identity of the terminal device based on the decrypted data; wherein the first public key is matched in pair with the first private key.

As a sixth aspect, the present disclosure provides an authentication server, including: a generation module configured to generate a third private key and a public key certificate, wherein the public key certificate records therein a third public key matched in pair with the third private key; and a certificate issuance module configured to sign, in response to a first public key sent from the terminal device, the first public key based on the third public key to generate an encrypted certificate and send the encrypted certificate to the terminal device, sign a second public key of the authentication server based on the third private key to generate a signed certificate and send the signed certificate to the terminal device, and send a public key certificate to the IoT platform so that the IoT platform verifies validity of the encrypted certificate and the signed certificate from the terminal device based on the public key certificate.

As a seventh aspect, the present disclosure provides an identity authentication system, including: the IoT platform, the terminal device, and the authentication server described above.

As an eighth aspect, the present disclosure provides an electronic device, including: one or more processors; and a storage device having one or more programs stored thereon, which when executed by the one or more processors, cause the one or more processors to implement the method in any one of the above embodiments.

As a ninth aspect, the present disclosure provides a computer-readable storage medium storing instructions thereon which, when executed by a processor, cause the processor to implement the method in any one of the above embodiments.

### BRIEF DESCRIPTION OF THE DRAWINGS

The accompanying drawings provide a further understanding of the present disclosure and form a part of the specification. The drawings are used together with the embodiments below to explain the present disclosure, but do not constitute a limitation on the present disclosure. In the drawings:

FIG. 1 is a schematic diagram showing a method for authenticating an identity in some embodiments of the present disclosure.

FIG. 2 is a flow chart showing an implementation of step S133 in some embodiments of the present disclosure.

FIG. 3 is a flow diagram showing a method for verifying an encrypted certificate and a signed certificate in some embodiments of the present disclosure.

FIG. 4 is a schematic diagram showing a method for authenticating an identity in other embodiments of the present disclosure.

FIG. 5 is a schematic diagram showing a process for issuing a certificate in some embodiments of the present disclosure.

FIG. 6 is a schematic diagram showing a method for authenticating an identity in other embodiments of the present disclosure.

FIG. 7 is a flow chart of an alternative implementation of step S223 in some embodiments of the present disclosure.

FIG. 8 is a flow chart showing a method for authenticating an identity in other embodiments of the present disclosure.

FIG. 9 is a schematic diagram showing a process for issuing a certificate in some embodiments of the present disclosure.

FIG. 10 is a flow chart showing a method for issuing a certificate in some embodiments of the present disclosure.

FIG. 11 is a flow chart showing a method for issuing a certificate in other embodiments of the present disclosure.

FIG. 12 is schematic diagram showing an interaction among a terminal device, an authentication server, and an IoT platform during a certificate issuance process.

FIG. 13 is a schematic diagram showing a process for authenticating an identity.

FIG. 14 is a schematic diagram showing an IoT platform in some embodiments of the present disclosure.

FIG. 15 is a schematic diagram showing a terminal device in some embodiments of the present disclosure.

FIG. 16 is a schematic diagram showing an authentication server in some embodiments of the present disclosure.

FIG. 17 is a schematic diagram showing an identity authentication system in some embodiments of the present disclosure.

### DETAILED DESCRIPTION OF THE EXEMPLARY EMBODIMENTS

The following detailed description of the embodiments of the present disclosure will be described in detail in combination with to the accompanying drawings. It should be understood that the embodiments described herein are only intended to illustrate and explain the present disclosure rather than to limit the present disclosure.

In order to make the objects, technical solutions and advantages of the embodiments of the present disclosure more apparent, the technical solutions of the embodiments of the present disclosure will be clearly and completely described below with reference to the drawings of the embodiments of the present disclosure. It is to be understood that the described embodiments are only a few embodiments of the present disclosure, and not all embodiments. All other embodiments, which can be derived by a person skilled in the art from the described embodiments of the present disclosure without inventive work, fall into the protection scope of the present disclosure.

Unless otherwise defined, technical or scientific terms in the embodiments of the present disclosure should have the ordinary meaning as understood by one of ordinary skill in the art to which the present disclosure belongs. The terms such as “first,” “second,” and the like in the present disclosure are not intended to indicate any order, quantity, or importance, but are used to distinguish one element from another.

In order to facilitate an understanding of the embodiments of the present disclosure, before illustrating the embodiments of the present disclosure in detail, specific terms related to the present disclosure are explained as follows:
(1) The certification authority (CA) all-in-one machine is an international term for certification bodies, and is the organization that issues, manages, and cancels digital certificates for applicants of the digital certificates. The role of the CA is to verify the validity of the identity of the certificate holder and issue a certificate (i.e., sign mathematically on the certificate) to prevent the certificate from being forged or tampered with. The certificate authority (CA) is a key link in the security of online electronic transactions, and is mainly responsible for generating, allocating, and managing the identity authentication digital certificates required by all entities participating in the online transactions. Each digital certificate is associated with a previous-level digitally signed certificate, and ultimately traced back, through a security chain, to a known and widely recognized secure, authoritative, and trustworthy organization, that is, a Root Certification Authority (i.e., the Root CA).
(2) The server cipher machine is a server-side password computing device that provides universal password service functions such as key generation, digital signature, signature verification, data encryption, and data decryption. The server cipher machine is a device that implements the transformation of plaintext to ciphertext or the transformation of ciphertext to plaintext, under the influence of a key. In the embodiment of the present disclosure, basic security services such as data encryption and decryption are provided by the server cipher machine for the internet of things platform.
(3) A digital signature (also known as a public key digital signature) is a string of digits that is only generated by a sender of information and cannot be forged by others. This string of digits is also an effective proof of the authenticity of the information sent from the sender. The digital signature is similar to a regular physical signature written on paper and is realized through techniques in the field of public key encryption for identifying digital information. A set of digital signatures typically defines two complementary operations, one of which is for signing/signature and the other is for verifying (i.e. verifying the signature). The signature in the embodiment of the present disclosure is signed with the private key and is verified with the public key.

In the embodiment of the present disclosure, the process of signing data A with a certain private key a may include: processing data A′ to be signed containing the data A through a hash algorithm to generate a first hash value; encrypting the first hash value by using the private key a to generate a digital signature; and generating signature data D based on the digital signature and the data A′ to be signed. When the digital signature is verified, the process may include decrypting the digital signature by using a public key a′ in pair with the private key a, and processing the data D by using a hash function to obtain a second hash value; and comparing the second hash value with the decryption result of the digital signature, and the digital signature is verified successfully in a case that the second hash value is the same as the decryption result of the digital signature.
(4) A digital certificate (also known as a public key certificate) is a declaration of a digital signature that binds a value of a public key to an identity of the individual, device, or service holding a corresponding private key. Most general-purpose certificates are based on X.509v3 certificate standard.
(5) Hash, commonly translated or transliterated as hash, transforms (also known as a pre mapping/pre-imaging) an input with any length into an output (i.e., the hash value) with a fixed length through a hash algorithm. The transformation is a compression mapping, which means that a space of the hash values is in generally much smaller than that of the inputs, and different inputs may be hashed into the same output, therefore it is impossible to determine a unique input value from the hash values. Simply put, the Hash is a function that compresses messages with any length into a message digest with a fixed length.
(6) The IoT platform is an integrated platform that integrates functions such as device management, data security communication, and message subscription. The IoT platform supports connecting massive devices downwards, collecting data from the devices, and uploading the data to the cloud; further supports providing cloud APIs upwards, so that a server may issue instructions to a device by calling the cloud APIs for achieving remote control. The IoT platform is a unified management platform for the massive devices in the present disclosure.
(7) Terminal devices are intermediate devices of a sensor network layer and a transmission network layer, and also the key devices of the internet of things. Through converting and collecting by the terminal device, the external sensor data may be collected, processed, and transmitted to the Internet via various network interfaces. The terminal devices in the embodiment of the present disclosure mainly are display terminal devices, such as displays, conference all-in-one machines, etc.

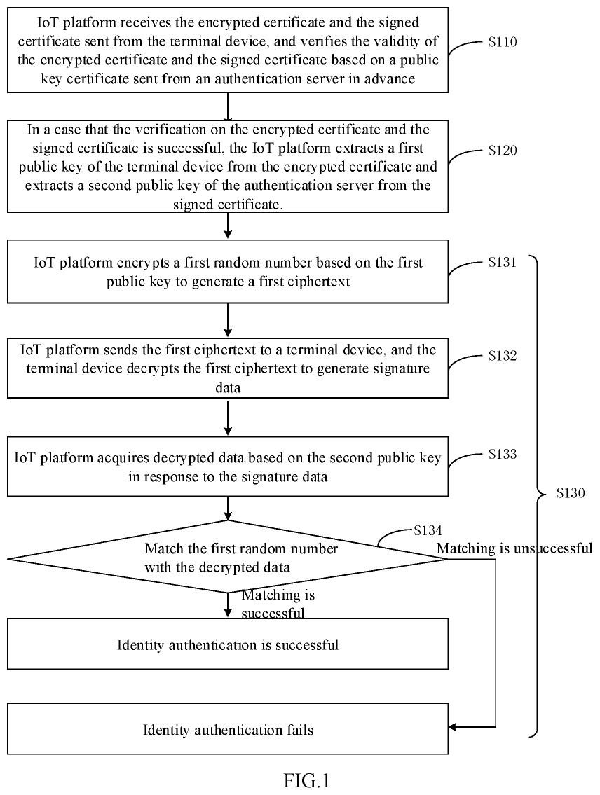

FIG. 1 is a schematic diagram showing a method for authenticating an identity in some embodiments of the present disclosure. The method for authenticating an identity (i.e., identity authentication method) as shown in FIG. 1 is applied to an IoT platform. As shown in FIG. 1, the method includes the following steps S110 to S130.

At step S110, the IoT platform receives an encrypted certificate and a signed certificate sent from a terminal device, and verifies the validity of the encrypted certificate and the signed certificate based on a public key certificate sent from an authentication server in advance.

Before identity authentication, the terminal device may receive the encrypted certificate and the signed certificate issued by the authentication server (i.e., the CA all-in-one machine described above), wherein a first public key PUB_A of the terminal device is recorded in the encrypted certificate, and a second public key PUB_C of the authentication server is recorded in the signed certificate. At step S110, the IoT platform verifies the validity of the encrypted certificate and the signed certificate, that is, the IoT platform verifies whether the encrypted certificate and the signed certificate actually sent from the terminal device are issued by the authentication server.

A third public key PUB_B of the authentication server is recorded in the public key certificate sent from the authentication server. When the IoT platform verifies the validity of the encrypted certificate and the signed certificate, the IoT platform verifies signatures for the encrypted certificate and the signed certificate based on the third public key. In a case that the verification of the signatures is successful, the encrypted certificate and the signed certificate are valid.

At step S120, in a case that the verification on the encrypted certificate and the signed certificate is successful, the IoT platform extracts the first public key PUB_A of the terminal device from the encrypted certificate and extracts the second public key PUB_C of the authentication server from the signed certificate.

At step S130, the IoT platform carries out bidirectional identity authentication with the terminal device based on the first public key PUB_A, the second public key PUB_C, and a fourth public key PUB_D of the IoT platform.

In some embodiments, step S130 includes steps S131 to S134.

At step S131, the IoT platform encrypts a first random number based on the first public key PUB_A to generate a first ciphertext. The first random number is data randomly generated by the IoT platform by using a server cipher machine.

At step S132, the IoT platform sends the first ciphertext to the terminal device, and the terminal device decrypts the first ciphertext to generate signature data.

It can be understood that the terminal device stores therein a first private key PRI_A matched in pair with the first public key PUB_A. The first ciphertext is decrypted based on the first private key PRI_A.

In some embodiments, the signature data is generated by the terminal device encrypting and signing the decryption result of the first ciphertext based on the fourth public key PUB_D of the IoT platform and a second private key PRI_C obtained in advance, respectively. The second private key PRI_C is matched in pair with the second public key PUB_C. The terminal device may acquire the fourth public key PUB_D and the second private key PRI_C in advance before the identity authentication.

When the terminal device generates the signature data, the terminal device may encrypt encryption the decryption result of the first ciphertext based on the fourth public key PUB_D, and then perform a signature operation based on the second private key PRI_C. For example, the terminal device may directly encrypt the decryption result of the first ciphertext by using the fourth public key PUB_D to generate first encrypted data; and sign the first encrypted data based on the second private key PRI_C to generate the signature data (hereinafter referred to as Method 1). For another example, Method 2: the terminal device may concatenate the decryption result of the first ciphertext with another random number; encrypt the concatenated data based on the fourth public key PUB_D to generate second encrypted data; and perform a signature operation on the second encrypted data based on the second private key PRI_C to generate the signature data (hereinafter, referred to as Method 2).

At step S133, the IoT platform acquires decrypted data based on the second public key PUB_C in response to the signature data.

The IoT platform may verify the signature for the signature data; and decrypt the ciphertext obtained after successful verification to obtain the decrypted data.

At step S134, the IoT platform matches the first random number with the decrypted data. In a case that the matching is successful, the identity authentication for the terminal device is successful; otherwise, the identity authentication for the terminal device fails.

For example, in some embodiments, the terminal device generates the signature data according to Method 1. In this case, at step S134, the IoT platform determines that the matching is successful in a case that the first random number is the same as the decrypted data. In other embodiments, the terminal device generates the signature data according to Method 2. In this case, at step S134, the IoT platform determines that the matching is successful in a case that a part of the decrypted data is the same as the first random number.

In a case that the first random number is matched with the decrypted data, at step S130, each private key used by the terminal device and each private key used by the IoT platform are both secure, that is, the identity authentication for the terminal device is successful.

In the embodiment of the present disclosure, the IoT platform verifies the encrypted certificate and the signed certificate sent from the terminal device to determine whether the encrypted certificate and the signed certificate are the certificates issued by the authentication server or not; in a case that the encrypted certificate and the signed certificate are the certificates issued by the authentication server, the IoT platform carries out the bidirectional identity authentication with the terminal device based on the first random number, and the first public key PUB_A and the second public key PUB_C extracted from the encrypted certificate and the signed certificate, respectively. In a case that the decrypted data finally returned from the terminal device is matched with the initial first random number, the private key used during the authentication process is safe, so that it is determined that the identity authentication for the terminal device is successful. Therefore, the validity and safety of the terminal device accessing the IoT platform can be ensured.

In a specific example, the signature data is generated by the terminal device signing a second ciphertext based on the second private key PRI_C; the second ciphertext is generated by the terminal device encrypting a second random number R_S|R_D based on the fourth public key PUB_D; and the second random number is data obtained by concatenating (i.e., concatenating and splicing) a decryption result of the first ciphertext with a third random number.

For example, the first random number is n-bit data, and the third random number is m-bit data. The second random number is data obtained by concatenating the decryption result of the first ciphertext with the third random number, and the third random number is located in front of the decryption result of the first ciphertext. In this case, at step S134, the IoT platform determines that the identity authentication for the terminal device is successful in a case that the last n bits in the decrypted data are the same as the first random number.

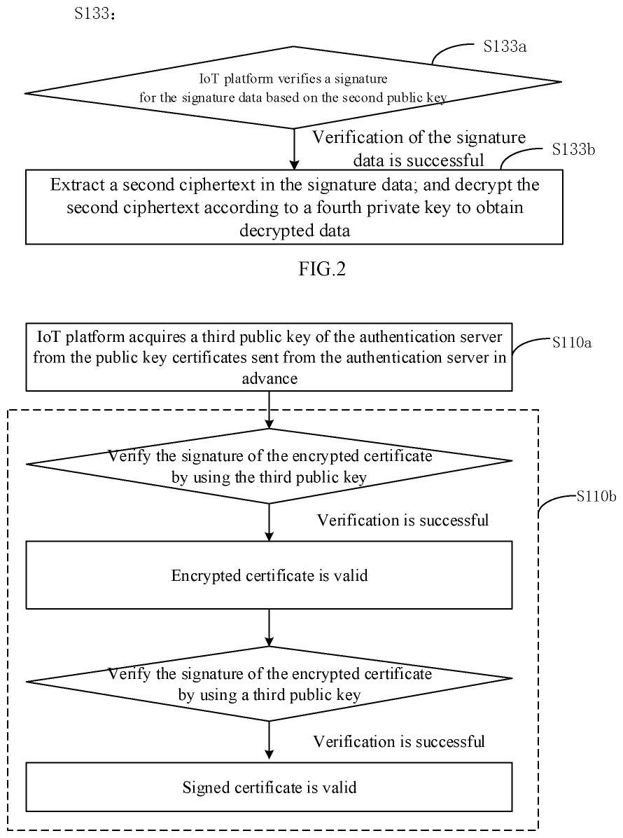

FIG. 2 is a flow chart showing an implementation of step S133 in some embodiments of the present disclosure. As shown in FIG. 2, step S133 may include the following steps S133a and S133b.

At step S133a, the IoT platform verifies the signature for the signature data based on the second public key PUB_C.

In a case that the verification is successful, step S133b is performed, including extracting the second ciphertext in the signature data; and decrypting the second ciphertext according to a fourth private key to obtain the decrypted data.

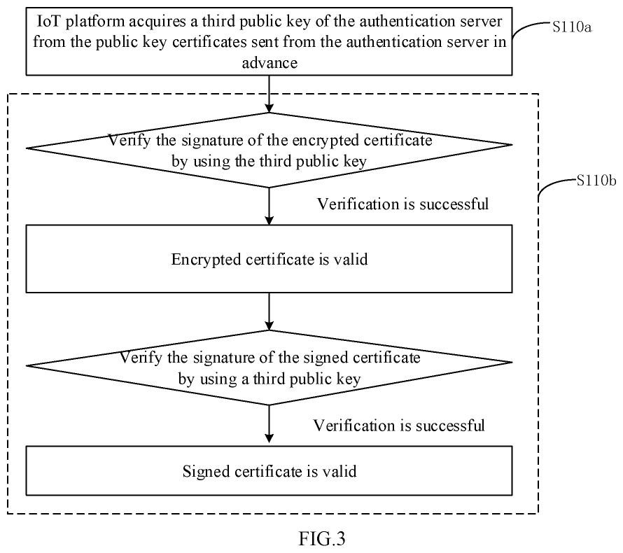

FIG. 3 is a flow diagram showing a method for verifying an encrypted certificate and a signed certificate in some embodiments of the present disclosure. As shown in FIG. 3, the method for verifying validity of the encrypted certificate and the signed certificate may include the following steps S110a and S110b.

At step S110a, the IoT platform acquires the third public key PUB_B of the authentication server from the public key certificates sent from the authentication server in advance.

At step S110b, the IoT platform verifies the signature of the encrypted certificate by using the third public key. In a case that the signature of the encrypted certificate passes the verification, the encrypted certificate is valid. The IoT platform verifies the signature of the signed certificate by using the third public key. In a case that the signature of the signed certificate passes the verification, the signed certificate is valid.

The IoT platform verifies the signatures of the encrypted certificate and the signed certificate by using the public key from the authentication server to determine whether the encrypted certificate and the signed certificate sent from the terminal device are issued by the authentication server or not.

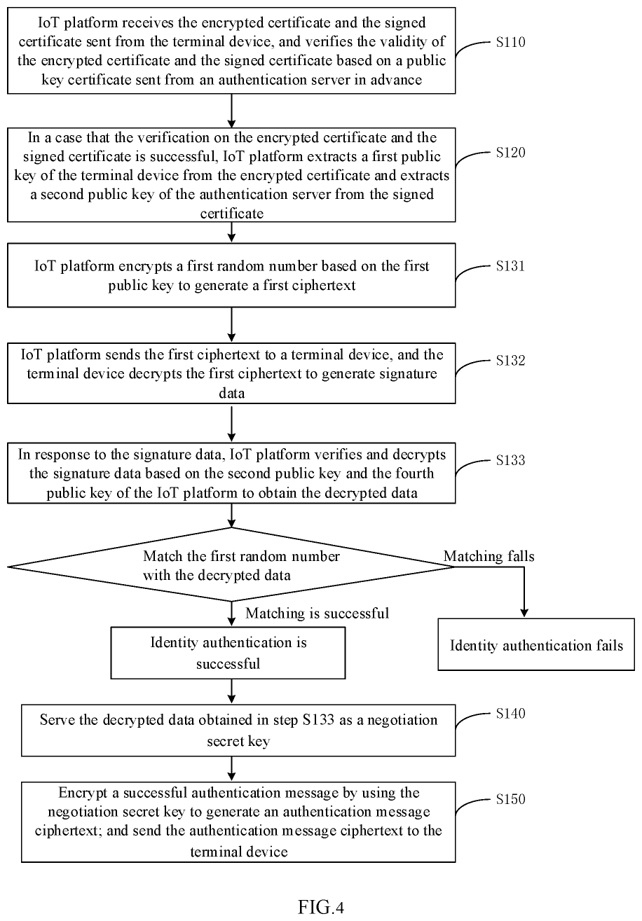

FIG. 4 is a schematic diagram showing a method for authenticating an identity in other embodiments of the present disclosure. As shown in FIG. 4, in some embodiments, in a case that the identity authentication for the terminal device is successful, the method further includes steps S140 and S150.

At step S140, serving the decrypted data obtained in step S133 as a negotiation secret key.

At step S150, encrypting a successful authentication message by using the negotiation secret key to generate an authentication message ciphertext; and sending the authentication message ciphertext to the terminal device.

The successful authentication message indicating that the authentication for the terminal device is successful is generated by the IoT platform.

In a case that the identity authentication is successful, the decrypted data decrypted by the IoT platform is the same as the second random number. After the IoT platform encrypts the successful authentication message by using the decrypted data, the terminal device may decrypt the successful authentication message by using the second random number to determine that the identity authentication is successful, and communicate with the IoT platform by using the second random number (i.e., the decrypted data obtained in step S133).

In some embodiments, the identity authentication method may further include a certificate issuance process before step S110. FIG. 5 is a schematic diagram showing a process for issuing a certificate (i.e., certificate issuance process) in some embodiments of the present disclosure. As shown in FIG. 5, the process includes steps S101 to S103.

At step S101, the IoT platform generates the fourth public key PUB_D and the fourth private key PRI_D matched in pair.

The IoT platform generates the fourth public key PUB_D and the fourth private key PRI_D by using the server cipher machine. The fourth private key PRI_D is stored in the IoT platform.

At step S102, the IoT platform sends the fourth public key PUB_D to the authentication server, and the authentication server signs the fourth public key PUB_D by using the third private key PRI_B to generate a platform certificate.

At step S103, the IoT platform receives and stores the platform certificate and the public key certificate sent from the authentication server.

The public key certificate records therein the third public key PUB_B matched in pair with the third private key PRI_B.

In other embodiments, alternatively, the authentication server may not send the platform certificate to the IoT platform.

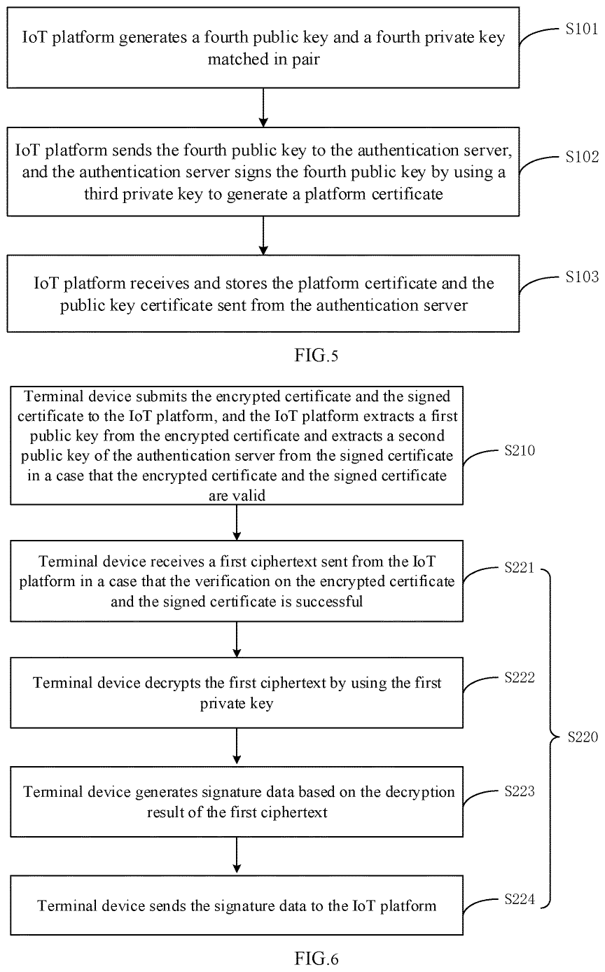

FIG. 6 is a schematic diagram showing a method for authenticating an identity in other embodiments of the present disclosure. The identity authentication method shown in FIG. 6 is applied to a terminal device such as a display terminal device or other terminal device. The terminal device may include a security chip, and the identity authentication method may be performed by the security chip. As shown in FIG. 6, the method includes the following steps S210 and S220.

At step S210, the terminal device submits the encrypted certificate and the signed certificate to the IoT platform, and the IoT platform extracts the first public key PUB_A from the encrypted certificate and extracts the second public key PUB_C of the authentication server from the signed certificate in a case that the encrypted certificate and the signed certificate are valid.

At step S220, in a case that the encrypted certificate and the signed certificate pass the verification, the terminal device carries out the bidirectional identity authentication with the IoT platform based on the second private key PRI_C of the authentication server, the fourth public key PUB_B of the IoT platform and the first private key PRI_A of the terminal device obtained in advance.

Step S220 may specifically include steps S221 to S224.

At step S221, the terminal device receives the first ciphertext sent from the IoT platform in a case that the verification on the encrypted certificate and the signed certificate is successful.

At step S222, the terminal device decrypts the first ciphertext by using the first private key, wherein the first public key PUB_A is matched in pair with the first private key PRI_A.

At step S223, the terminal device generates signature data based on the decryption result of the first ciphertext.

At step S224, the terminal device sends the signature data to the IoT platform, and the IoT platform acquires decrypted data based on the second public key PUB_C. After the IoT platform acquires the decrypted data, the IoT platform may authenticate the identity of the terminal device based on the decrypted data.

In some embodiments, step S223 may include: encrypting and signing the decryption result of the first ciphertext based on the fourth public key PUB_D of the IoT platform and the second private key PRI_C obtained in advance to generate the signature data. The second public key PUB_C is matched in pair with the second private key PRI_C, and the second private key PUB_C and the fourth public key PUB_D are both obtained by the terminal device in advance.

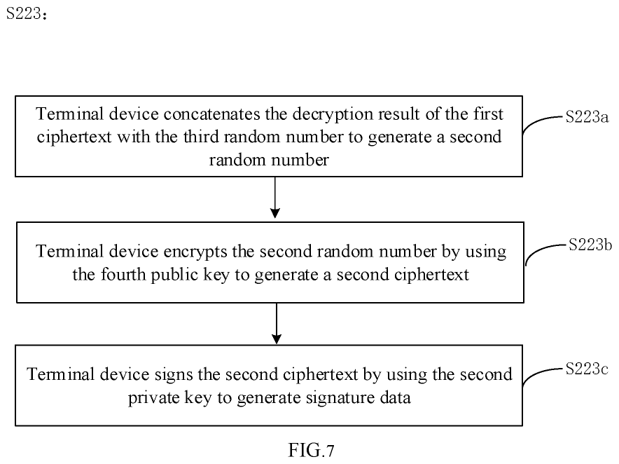

FIG. 7 is a flow chart of an alternative implementation of step S223 in some embodiments of the present disclosure. As shown in FIG. 7, the step S223 may include the following steps S223a to S223c.

At step S223a, the terminal device concatenates the decryption result of the first ciphertext with the third random number to generate a second random number.

For example, the first random number is n-bit data, the third random number is m-bit data. The second random number is obtained by concatenating the decryption result of the first random number behind the third random number.

At step S223b, the terminal device encrypts the second random number by using the fourth public key PUB_D to generate a second ciphertext.

At step S223c, the terminal device signs the second ciphertext by using the second private key PRI_C to generate signature data.

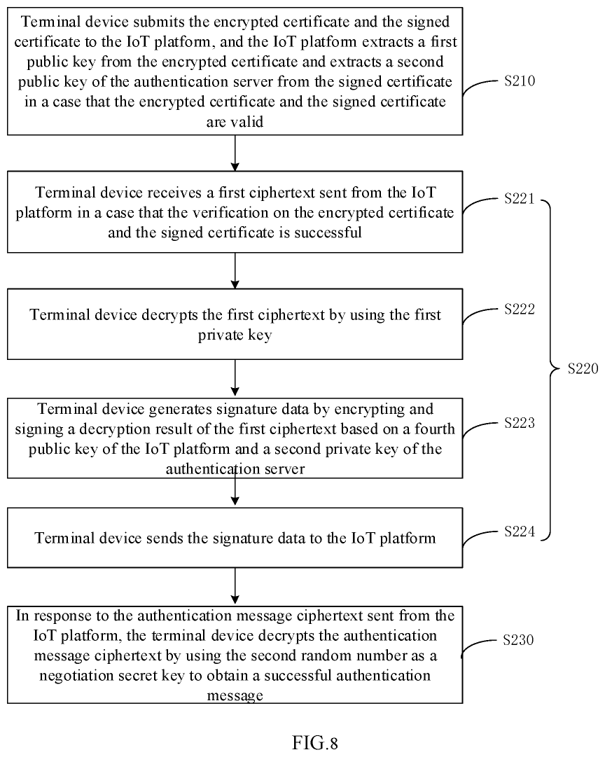

FIG. 8 is a flow chart showing a method for authenticating an identity in other embodiments of the present disclosure. As shown in FIG. 8, the identity authentication method may further include step S230 in addition to the above steps S210 to S223.

At step S230, in response to the authentication message ciphertext sent from the IoT platform, the terminal device decrypts the authentication message ciphertext by using the second random number as a negotiation secret key to obtain an successful authentication message.

It can be understood that the authentication message ciphertext is generated by the IoT platform encrypting the successful authentication message after the IoT platform determines that the identity authentication for the terminal device is successful. Therefore, in a case that the IoT platform generates and transmits the authentication message ciphertext, the second random number is the same as decrypted data used when the IoT platform encrypts. After the terminal device decrypts the authentication message ciphertext by using the second random number, the plaintext of the successful authentication message generated by the IoT platform may be obtained, thereby determining that the identity authentication of the device is successful.

In some embodiments, the identity authentication method may further include a certificate issuance process before step S210. FIG. 9 is a schematic diagram showing a process for issuing a certificate in some embodiments of the present disclosure. As shown in FIG. 9, the process includes steps S201 to S204.

At step S201, the terminal device generates a first public key PUB_A and a first private key PRI_A matched with each other in pair.

At step S202, the terminal device sends the first public key PUB_A to the authentication server, and the authentication server signs the first public key PUB_A by using a third private key PRI_B to generate an encrypted certificate.

At step S203, the terminal device receives and stores the encrypted certificate, the signed certificate and the platform certificate which are sent from the authentication server. The fourth public key PUB_D of the IoT platform is recorded in the platform certificate, and the signed certificate is generated by the authentication server signing the second public key PUB_C by using the third private key PRI_B.

At step S204, in response to the private key ciphertext sent from the authentication server, the terminal device decrypts the private key ciphertext by using the first private key PRI_A to obtain and store a second private key PRI_C. The private key ciphertext is generated by the authentication server encrypting the second private key PRI_C by using the first public key PUB_A.

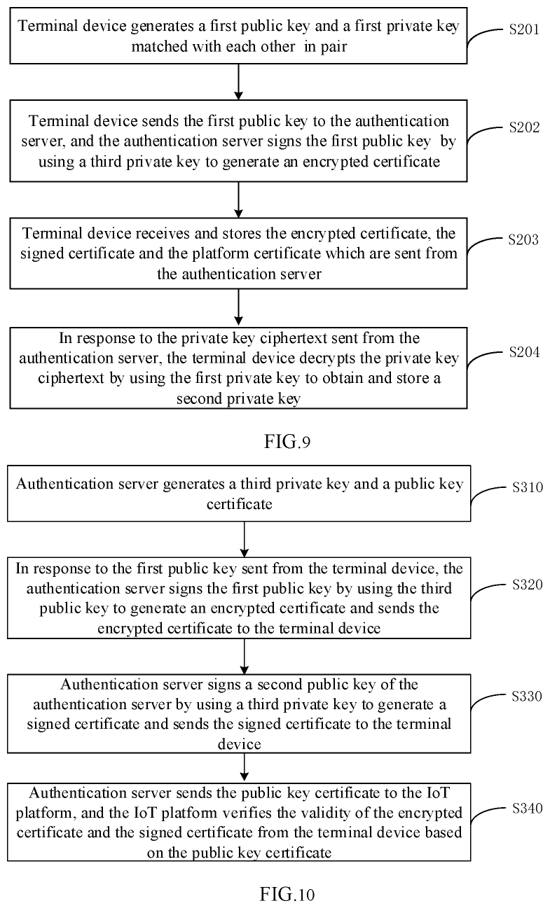

FIG. 10 is a flow chart showing a method for issuing a certificate (i.e., a certificate issuance method) applied to the authentication server in some embodiments of the present disclosure. As shown in FIG. 10, the method for issuing a certificate includes the following steps S310 to S350.

At step S310, the authentication server generates a third private key PRI_B and a public key certificate, wherein a third public key PUB_B matched in pair with the third private key PRI_B is recorded in the public key certificate.

At step S320, in response to the first public key PUB_A sent from the terminal device, the authentication server signs the first public key PUB_A by using the third public key PUB_B to generate an encrypted certificate and sends the encrypted certificate to the terminal device. The terminal device receives and stores the encrypted certificate, and sends the encrypted certificate to the IoT platform during the identity authentication process.

At step S330, the authentication server signs the second public key PUB_C of the authentication server by using the third private key PRI_B to generate the signed certificate and sends the signed certificate to the terminal device. The terminal device receives and stores the signed certificate, and sends the signed certificate to the IoT platform during the identity authentication process.

At step S340, the authentication server sends the public key certificate to the IoT platform, and the IoT platform verifies the validity of the encrypted certificate and the signed certificate from the terminal device based on the public key certificate. The third public key PUB_B is recorded in the public key certificate. The IoT platform extracts the third public key PUB_B from the public key certificates during the identity authentication process, and verifies, based on the third public key PUB_B, whether the encrypted certificate and the signed certificate uploaded by the terminal device are signed and issued by the authentication server.

In some embodiments, the certificate issuance method further includes step 350. At step 350, the authentication server encrypts the second private key PRI_C to generate a private key ciphertext, and sends the private key ciphertext to the terminal device. The terminal device decrypts the private key ciphertext to obtain the second private key PRI_C.

The authentication server may encrypt the second private key PRI_C by using the first public key PUB_A of the terminal device to generate the private key ciphertext. After the terminal device receives the private key ciphertext, the terminal device decrypts the private key ciphertext by using the first private key PRI_A stored in the terminal device to obtain and store a second private key PRI_C. During the subsequent identity authentication process, the terminal device may sign the data with the second private key PRI_C.

The sequence of the steps S320 to S350 is not particularly limited.

FIG. 11 is a flow chart showing a method for issuing a certificate in other embodiments of the present disclosure. As shown in FIG. 11, the method further includes steps S325 to S326.

At step S325, in response to the fourth public key PUB_D sent from the IoT platform, the authentication server signs the fourth public key PUB_D by using the third private key PRI_B to generate a platform certificate.

At step S326, the authentication server sends the platform certificate to the terminal device, and the terminal device extracts the fourth public key PUB_D of the IoT platform from the platform certificate.

The authentication server may further simultaneously send the platform certificate to the IoT platform.

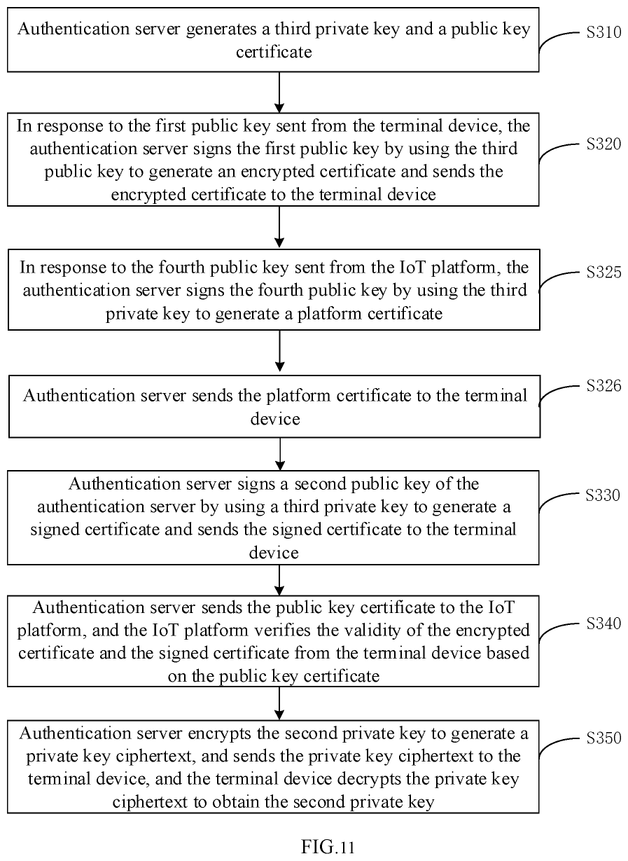

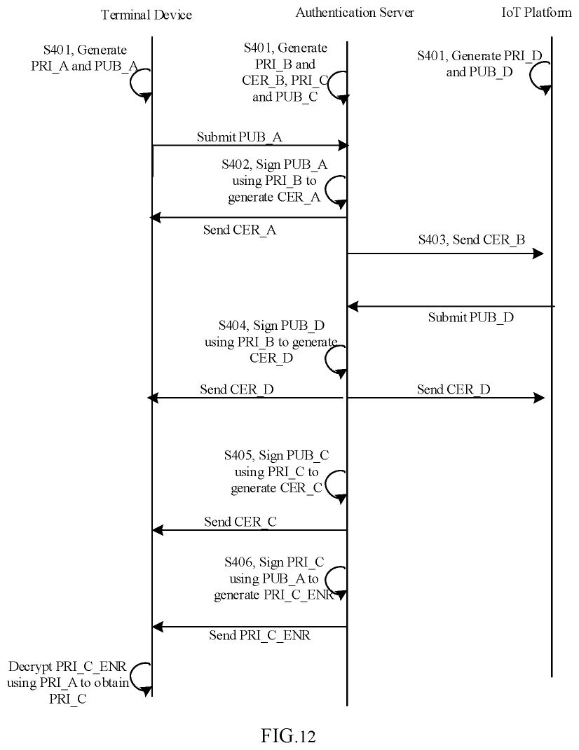

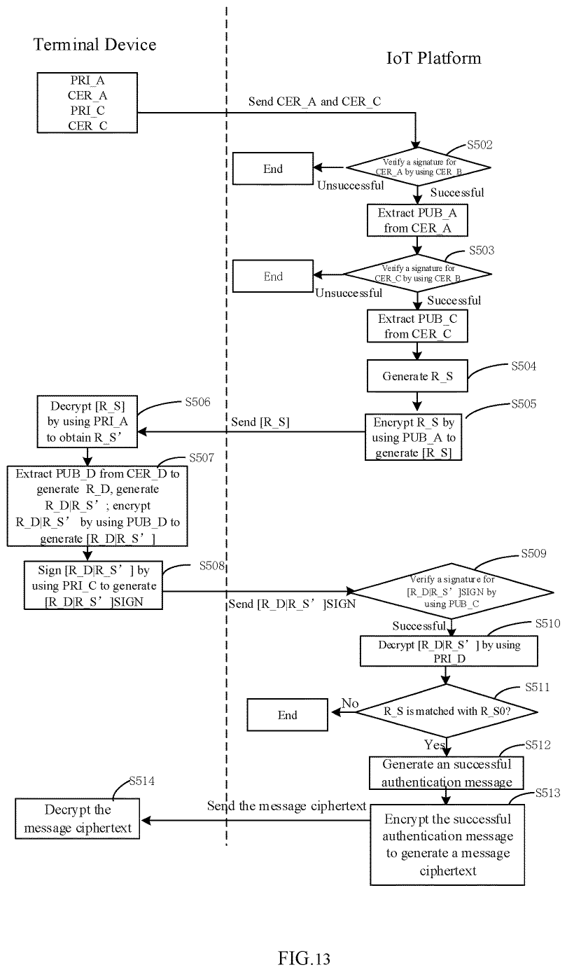

The identity authentication method of the identity authentication system will be described below. The identity authentication system includes a terminal device, an authentication server and an IoT platform. The identity authentication method includes a certificate issuance process and an identity authentication process. FIG. 12 is schematic diagram showing an interaction among a terminal device, an authentication server, and an IoT platform during a certificate issuance process, and FIG. 13 is a schematic diagram showing an identity authentication process. As shown in FIG. 12, the certificate issuance process includes the following steps S401 to S406.

At step S401, the IoT terminal generates a first public key PUB_A and a first private key PRI_A which are matched in pair. The authentication server generates a second public key PUB_C and a second private key PRI_C which are matched in pair, a third private key PRI_B and a public key certificate CER_B. The public key certificate CER_B records therein a third public key PUB_B matched in pair with the third private key PRI_B. The IoT platform generates a fourth public key PUB_D and a fourth private key PRI_D which are matched in pair.

At step S402, the terminal device submits the first public key PUB_A to the authentication server. The authentication server signs the first public key PUB_A by using the third private key PRI_B of the authentication server to generate an encrypted certificate CER_A, and sends the encrypted certificate CER_A to the terminal device.

At step S403, the authentication server sends the public key certificate CER_B to the IoT platform.

At step S404, the IoT platform submits the fourth public key PUB_D to the authentication server. The authentication server signs the fourth public key PUB_D by using the third private key PRI_B to generate a platform certificate CER_D of the IoT platform, and sends the platform certificate CER_D to the terminal device. Meanwhile, the platform certificate CER_D may further be sent to the IoT platform.

At step S405, the authentication server signs the second public key PUB_C by using the third private key PRI_B to generate a signed certificate CER_C, and returns the signed certificate CER_C to the terminal device.

At step S406, the authentication server encrypts the second private key PRI_C by using the first public key PUB_A to generate a private key ciphertext PRI_C_ENR, and returns the private key ciphertext PRI_C_ENR to the terminal device. The terminal device decrypts the private key ciphertext PRI_C_ENR by using the first private key PRI_A of the terminal device to obtain and store the second private key PRI_C.

After the certificate issuance process is finished, the terminal device stores therein: the first private key PRI_A and the corresponding encrypted certificate CER_A, the second private key PRI_C and the corresponding signed certificate CER_C, and the platform certificate CER_D of the IoT platform. The authentication server stores therein: the third private key PRI_B and the corresponding public key certificate CER_B, and the second private key PRI_C and the corresponding second public key PUB_C. The IoT platform stores therein: the fourth private key PRI_D, the platform certificate CER_D, and the public key certificate CER_B of the authentication server.

As shown in FIG. 13, the identity authentication process includes the following steps S501 to S514.

At step S501, the terminal device sends an encrypted certificate CER_A and a signed certificate CER_C to the IoT platform.

At step S502, the IoT platform verifies the signature for the encrypted certificate CER_A by using the public key certificate CER_B to verify the validity of the encrypted certificate CER_A, that is, to verify whether the encrypted certificate CER_A is a digital certificate signed and issued by the authentication server. If the encrypted certificate CER_A passes the verification, the IoT platform extracts the first public key PUB_A from the encrypted certificate CER_A, and step S503 is executed; if the verification on the encrypted certificate CER_A fails, the identity authentication process ends.

At step S503, the IoT platform verifies the signature for the signed certificate CER_C by using the public key certificate CER_B to verify the validity of the signed certificate CER_C, that is, to verify whether the signed certificate CER_C is a digital certificate signed and issued by the authentication server. If the verification on the signed certificate CER_C is successful, the IoT platform extracts the second public key PUB_C from the signed certificate CER_C, and step 504 is executed; if the verification on the signed certificate CER_C fails, the identity authentication process ends.

Through the steps S501 to S503, the IoT platform realizes the verification of the encrypted certificate CER_A and the signed certificate CER_C sent from the terminal device.

At step S504, the IoT platform generates a first random number R_S.

At step S505, the IoT platform encrypts the first random number R_S by using the first public key PUB_A to generate a first ciphertext [R_S], and sends the first ciphertext [R_S] to the IoT terminal.

At step S506, the terminal device decrypts the first ciphertext [R_S] by using the first private key PRI_A of the terminal device to obtain first decrypted data R_S′.

At step S507, the terminal device extracts the fourth public key PUB_D from the platform certificate CER_D to generate a third random number R_D, concatenates the third random number with the first decrypted data R_S′ to acquire a second random number R_D|R_S′, and encrypts the second random number R_D|R_S′ by using the fourth public key PUB_D to generate a second ciphertext [R_D|R_S′].

At step S508, the terminal device signs the second ciphertext [R_D|R_S′] by using the second private key PRI_C to generate signature data [R_D|R_S′]|SIGN, and sends the signature data [R_D|R_S′]|SIGN to the IoT platform.

At step S509, the IoT platform verifies the signature for the signature data [R_D|R_S′]|SIGN by using the second public key PUB_C. If the verification fails, the process ends. If the verification is successful, step S510 is executed.

At step S510, the IoT platform extracts the second ciphertext [R_D|R_S′] from the signature data [R_D|R_S′]|SIGN, and decrypts the second ciphertext [R_D|R_S′] by using the fourth private key PRI_D to obtain second decrypted data R_D0|R_S0.

At step S511, the IoT platform judges whether the second decrypted data is matched with the first random number or not; and if so, the identity authentication for the terminal device is successful.

Since the IoT platform cannot determine the real data of the third random number R_D, the IoT platform only needs to determine whether R_S0 in the second decrypted data is the same as the first random number R_S at step S511 or not. If R_S0 in the second decrypted data is the same as the first random number R_S, the second decrypted data is matched with the first random number.

A rule for concatenating the first decrypted data with the third random number may be pre-defined for the IoT platform and the terminal device. For example, the first decrypted data is concatenated behind the third random number to generate the second random number. In this case, at step S511, the IoT platform may judge whether the last n bits of the second decrypted data are the same as the first random number R_S, wherein n is the number of bits of the first random number R_S.

When the identity authentication for the terminal device is successful at step S511, the IoT platform and the terminal device determines that the second decrypted data is the same as the second random number R_D|R_S, so that the second decrypted data (i.e., the second random number R_D|R_S) is served as a negotiation key, and step S512 is executed.

At step S512, the IoT platform generates a successful authentication message representing that the identity authentication for the device terminal is successful.

At step S513, the IoT platform encrypts the successful authentication message by using the negotiation key to generate a message ciphertext, and sends the message ciphertext to the terminal device.

At step S514, after the terminal device receives the message ciphertext, the terminal device decrypts the message ciphertext by using the negotiation key to acquire a plaintext of the successful authentication message, and the terminal device may determine that the identity authentication is successful. The negotiation key is served as a key for subsequent communications.

FIG. 14 is a schematic diagram showing an IoT platform in some embodiments of the present disclosure. As shown in FIG. 14, the IoT platform includes: a verification module 110, an extraction module 120, and a first identity authentication module 130.

The verification module 110 is configured to receive an encrypted certificate and a signed certificate that are sent from the terminal device; and verify the validity of the encrypted certificate and the signed certificate based on a public key certificate sent by an authentication server in advance.

The extraction module 120 is configured to, in a case where the verification on the encrypted certificate and the signed certificate are successful, extract a first public key of the terminal device from the encrypted certificate, and extract a second public key of the authentication server from the signed certificate.

The first identity authentication module 130 is configured to encrypt a first random number based on the first public key to generate a first ciphertext; send the first ciphertext to the terminal device so that the terminal device decrypts the first ciphertext to generate signature data; acquire decrypted data based on the second public key in response to the signature data; and match the first random number with the decrypted data, and determine that the identity authentication for the terminal device is successful if the first random number is successfully matched with the decrypted data. The first random number is data generated by the IoT platform randomly by using a server cipher machine.

The signature data is generated by the IoT platform encrypting and signing a decryption result of the first ciphertext based on a fourth public key of the IoT platform, a second private key obtained in advance. The second private key is matched in pair with the second public key. In order to obtain the decrypted data, the signature data is verified and decrypted based on the second public key and the fourth private key of the IoT platform to obtain the decrypted data.

In some embodiments, verifying (i.e., verifying the signature for) and decrypting, by the first identity authentication module 130, the signature data based on the second public key, the fourth private key of the IoT device, specifically includes: verifying the signature for the signature data by using the second public key; and in a case where the verification is successful, decrypting the second ciphertext obtained in case of successful verification by using the fourth private key.

In some embodiments, the IoT platform may further include a message sending module configured to serve the decrypted data as a negotiation key in a case that the identity authentication for the terminal device is successful; and encrypt the successful authentication message by using the negotiation key to generate an authentication message ciphertext; and send the authentication message ciphertext to the terminal device.

In some embodiments, verifying, by the verification module 110, the validity of the encrypted certificate and the signed certificate based on a public key certificate sent from the authentication server in advance, specifically includes: acquiring a third public key of the authentication server from the public key certificates sent from the authentication server in advance; verifying the signature for the encrypted certificate by using the third public key; determining that the encrypted certificate is valid in a case that the verification of the encrypted certificate is successful; and verifying the signature for the signed certificate by using the third public key, and determining that the signed certificate is valid in a case that the verification of the signed certificate is successful.

In some embodiments, the IoT platform may further include a first secret key generation module and a first storage module. The first secret key generation module is configured to generate a fourth public key and a fourth private key which are matched in pair, and send the fourth public key to the authentication server, so that the authentication server signs the fourth public key by using the third private key to generate a platform certificate. The first storage module is configured to receive and store the public key certificate sent from the authentication server, wherein the public key certificate stores therein the third public key matched in pair with the third private key.

FIG. 15 is a schematic diagram showing a terminal device in some embodiments of the present disclosure. As shown in FIG. 15, the terminal device includes: a sending module 210 and a second identity authentication module 220.

The sending module 210 is configured to submit an encrypted certificate and a signed certificate to the IoT platform, so that the IoT platform extracts a first public key from the encrypted certificate and extracts a second public key of the authentication server from the signed certificate in a case that the encrypted certificate and the signed certificate are valid.

The second identity authentication module 220 is configured to, receive a first ciphertext sent from the IoT platform in a case that the verification of the encrypted certificate and the signed certificate are successful; decrypt the first ciphertext by using a first private key of the terminal device; generate signature data based on a decryption result of the first ciphertext; and send the signature data to the IoT platform so that the IoT platform acquires decrypted data based on a second public key and authenticate the identity of the terminal device based on the decrypted data, wherein the first public key is matched in pair with the first private key.

In order to generate the signature data, the decryption result of the first ciphertext is encrypted and signed based on a fourth public key of the IoT platform and a second private key obtained in advance to generate the signature data, wherein the second public key is matched in pair with the second private key.

The terminal device may include a security chip, and the sending module 210 and the second identity authentication module 220 may be integrated in the security chip.

In some embodiments, the encrypting and signing, by the second identity authentication module 220, the decryption result of the first ciphertext based on the fourth public key of the IoT platform and the second private key, specifically includes: concatenating the decryption result of the first ciphertext with a third random number to generate a second random number; encrypting the second random number by using the fourth public key to generate a second ciphertext; and signing the second ciphertext by using the second private key to generate the signature data.

In some embodiments, the terminal device further includes a decryption module configured to in response to an authentication message ciphertext sent from the IoT platform, decrypt the authentication message ciphertext by using the second random number as a negotiation key to obtain a successful authentication message.

In some embodiments, the terminal device further includes a second secret key generation module and a second storage module. The second secret key generation module is configured to generate a first public key and a first private key which are matched in pair; and send the first public key to the authentication server, so that the authentication server signs the first public key by using a third private key to generate the encrypted certificate. The second storage module is configured to receive and store the encrypted certificate, the signed certificate and the platform certificate which are sent from the authentication server; decrypt, in response to a private key ciphertext sent from the authentication server, the private key ciphertext by using the first private key to obtain and store the second private key.

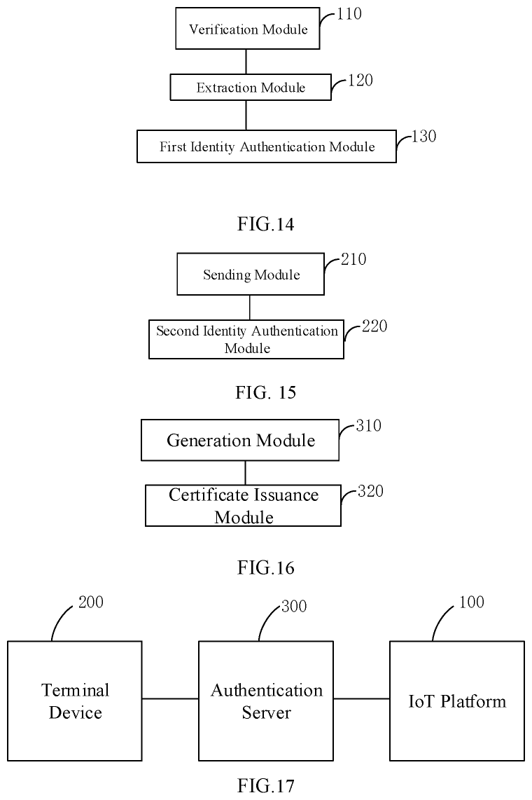

FIG. 16 is a schematic diagram showing an authentication server in some embodiments of the present disclosure. As shown in FIG. 16, the authentication server includes a generation module 310 and a certificate issuance module 320.

The generation module 310 is configured to generate a third private key and a public key certificate, wherein the public key certificate records therein a third public key matched in pair with the third private key.

The certificate issuance module 320 is configured to sign, in response to the first public key sent from the terminal device, the first public key by using the third public key to generate an encrypted certificate and send the encrypted certificate to the terminal device; and sign a second public key of the authentication server by using the third private key to generate a signed certificate and send the signed certificate to the terminal device; and send the public key certificate to the IoT platform so that the IoT platform verifies the validity of the encrypted certificate and the signed certificate from the terminal device based on the public key certificate.

In some embodiments, the authentication server further includes an encryption module configured to encrypt the second private key to generate a private key ciphertext; and send the private key ciphertext to the terminal device, so that the terminal device decrypts the private key ciphertext to obtain the second private key.

In some embodiments, the certificate issuance module 320 is further configured to sign, in response to a fourth public key sent from the IoT platform, the fourth public key by using the third private key to generate the platform certificate; and send the platform certificate to the terminal device and the IoT platform.

FIG. 17 is a schematic diagram showing an identity authentication system in some embodiments of the present disclosure. As shown in FIG. 17, the identity authentication system includes: the IoT platform 100, the terminal device 200, and the authentication server 300 described in above embodiments.

An embodiment of the present disclosure further provides an electronic device, which includes:
One or more processors;
A storage device having one or more programs stored thereon, which when executed by the one or more processors, cause the one or more processors to implement the identity authentication method or the certificate issuance method in any one of the above embodiments.

The electronic device further includes one or more I/O interfaces coupled between the one or more processors and the storage device and configured to enable information interaction between the one or more processors and the storage device.

Each processor is a device with data processing capability, which includes, but is not limited to, a Central Processing Unit (CPU) and the like. The storage device is a device with data storage capabilities, which includes, but is not limited to, random access memory (RAM, more specifically, SDRAM, DDR, etc.), Read Only Memory (ROM), Electrically Erasable Programmable Read Only Memory (EEPROM), FLASH. Each I/O interface (read/write interface) is coupled between the one or more processors and the storage device and configured to enable information interaction between the one or more processors and the storage device. The I/O interface includes but is not limited to a data bus and the like.

In some embodiments, the one or more processors, the storage device, and the one or more I/O interfaces are interconnected via a bus, which in turn coupled to other components of the computing device.

An embodiment further provides a computer-readable medium having a computer program stored thereon, where the computer program is executed by a processor to cause the processor to implement the identity authentication method or the certificate issuance method in any one of the embodiments above. In order to avoid repeated descriptions, detailed steps of the method will not be described herein again.

It will be understood by a person skilled in the art that all or some of the steps of the methods, functional modules/units in systems, devices in the present disclosure may be implemented as software, firmware, hardware, or suitable combinations thereof. In a hardware implementation, the division between functional modules/units mentioned in the above description does not necessarily correspond to the division of physical components. For example, one physical component may have multiple functions, or one function or step may be performed by several physical components in cooperation. Some or all of the physical components may be implemented as software executed by a processor, such as a central processing unit, a digital signal processor, or a microprocessor, or implemented as hardware, or implemented as an integrated circuit, such as an application specific integrated circuit. Such software may be distributed on computer-readable media which includes computer storage media (or non-transitory media) and communication media (or transitory media). As well known to a person skilled in the art, the term computer storage media include volatile and nonvolatile, removable and non-removable media implemented in any method or technology for storage of information such as computer-readable instructions, data structures, program modules or other data. The computer storage media include but are not limited to, RAM, ROM, EEPROM, FLASH or other memory technology, CD-ROM, Digital Versatile Disks (DVD) or other optical disk storage, magnetic cassettes, magnetic tape, magnetic disk storage or other magnetic storage devices, or any other media which can be used to store the desired information and which can accessed by a computer. In addition, it is well known to a person skilled in the art that communication media typically include computer-readable instructions, data structures, program modules or other data in a modulated data signal such as a carrier wave or other transport mechanism and may include any information delivery media.

It should be noted that in this document, the terms “include” “comprise”, or any other variation thereof, are intended to cover a non-exclusive inclusion, such that a process, method, article, or apparatus that comprises a list of elements not only include those elements but also may include other elements not expressly listed or inherent to such process, method, article, or apparatus. Without further limitation, an element identified by the phrase “comprising an . . . ” does not exclude the presence of other identical elements in the process, method, article, or apparatus that comprises the element.

It will be understood that the above embodiments are merely exemplary embodiments employed to illustrate the principles of the present disclosure, and the present disclosure is not limited thereto. It will be apparent to a person skilled in the art that various changes and modifications can be made therein without departing from the spirit and essence of the present disclosure, and these changes and modifications are to be considered within the scope of the present disclosure.

1. An identity authentication method for an internet of things platform, comprising:
receiving an encrypted certificate and a signed certificate sent from a terminal device, and verifying validity of the encrypted certificate and the signed certificate based on a public key certificate sent from an authentication server in advance;
extracting a first public key of the terminal device from the encrypted certificate, and extracting a second public key of the authentication server from the signed certificate in response that the verification of the encrypted certificate and the signed certificate is successful;
encrypting a first random number based on the first public key to generate a first ciphertext, wherein the first random number is data randomly generated by the internet of things platform by using a server cipher machine;
sending the first ciphertext to the terminal device, so that the terminal device decrypts the first ciphertext to generate signature data;
acquiring decrypted data based on the second public key in response to the signature data; and
matching the first random number with the decrypted data, and determining that identity authentication for the terminal device is successful in response to the first random number being successfully matched with the decrypted data.

2. The identity authentication method of claim 1, wherein
the signature data is generated by the terminal device encryping and signing a decryption result of the first ciphertext based on a fourth public key of the internet of things platform and a second private key obtained in advance, wherein the second private key is matched in pair with the second public key; and
the decrypted data is generated by verifying and decrypting the signature data based on the second public key and a fourth private key of the internet of things platform.

3. The identity authentication method of claim 1, wherein
the signature data is generated by the terminal device signing a second ciphertext with the second private key;
the second ciphertext is generated by the terminal device encrypting a second random number based on the fourth public key, and
the second random number is data generated by concatenating a decryption result of the first ciphertext with a third random number.

4. The identity authentication method of claim 3, wherein acquiring the decrypted data based on the second public key in response to the signature data, comprises:
verifying a signature for the signature data by using the second public key in response to the signature data; and
decrypting, based on the fourth private key, the second ciphertext obtained by verifying the signature for the signature data in response that the verification of the signature data is successful.

5. The identity authentication method of claim 3, wherein in response that the identity authentication for the terminal device is successful, the method further comprises:
serving the decrypted data as a negotiation key;
encrypting successful authentication message by using the negotiation key to generate an authentication message ciphertext; and
sending the authentication message ciphertext to the terminal device.

6. The identity authentication method of claim 1, wherein verifying the validity of the encrypted certificate and the signed certificate based on the public key certificate sent from the authentication server in advance, comprises:
acquiring a third public key of the authentication server from the public key certificate sent from the authentication server in advance;
verifying the encrypted certificate with the third public key, and determining that the encrypted certificate is valid in response that the verification of the encrypted certificate is successful; and
verifying a signature for the signed certificate with the third public key, and determining that the signed certificate is valid in response that verification of the signed certificate is successful.

7. The identity authentication method of claim 1, wherein prior to receiving the encrypted certificate and the signed certificate sent from the terminal device, the method further comprises:
receiving and storing the public key certificate sent from the authentication server, wherein the public key certificate records therein a third public key matched in pair with a third private key;
generating a fourth public key and a fourth private key matched in pair; and
sending the fourth public key to the authentication server, so that the authentication server signs the fourth public key by using the third private key to generate a platform certificate.

8. An identity authentication method for a terminal device, comprising:
submitting an encrypted certificate and a signed certificate to an internet of things platform, so that the internet of things platform extracts a first public key from the encrypted certificate and extracts a second public key of an authentication server from the signed certificate in response that the encrypted certificate and the signed certificate are valid;
receiving a first ciphertext sent from the internet of things platform in response that verification of the encrypted certificate and the signed certificate is successful;
decrypting the first ciphertext by using a first private key of the terminal device, wherein the first public key is matched in pair with the first private key;
generating signature data based on a decryption result of the first ciphertext; and
sending the signature data to the internet of things platform, so that the internet of things platform acquires decrypted data based on the second public key, and authenticates the identity of the terminal device based on the decrypted data.

9. The identity authentication method of claim 8, wherein generating the signature data based on the decryption result of the first ciphertext, comprises:
encrypting and signing the decryption result of the first ciphertext based on a fourth public key of the internet of things platform and a second private key obtained in advance to generate the signature data, wherein the second public key is matched in pair with the second private key.

10. The identity authentication method of claim 9, wherein encrypting and signing the decryption result of the first ciphertext based on the fourth public key of the internet of things platform and the second private key obtained in advance to generate the signature data, comprises:
concatenating the decryption result of the first ciphertext with a third random number to generate a second random number;
encrypting the second random number by using the fourth public key to generate a second ciphertext; and
signing the second ciphertext by using the second private key to generate the signature data.

11. The identity authentication method of claim 10, further comprising:
in response to an authentication message ciphertext sent from the internet of things platform, decrypting the authentication message ciphertext by using the second random number as a negotiation key to obtain a successful authentication message.

12. The identity authentication method of claim 8, wherein prior to submitting the encrypted certificate and the signed certificate to the internet of things platform, the method further comprises:
generating the first public key and the first private key matched in pair;
sending the first public key to the authentication server, so that the authentication server signs the first public key by using a third private key to generate the encrypted certificate;
receiving and storing the encrypted certificate, the signed certificate and a platform certificate sent from the authentication server, wherein the platform certificate records therein a fourth public key of the internet of things platform, and the signed certificate is generated by the authentication server signing the second public key with the third private key; and
decrypting, in response to a private key ciphertext sent from the authentication server, the private key ciphertext based on the first private key to obtain and store a second private key.

13. A certificate issuance method for an authentication server, comprising:
generating a third private key and a public key certificate, wherein the public key certificate records therein a third public key matched in pair with the third private key;
signing, in response to a first public key sent from terminal device, the first public key based on the third public key to generate an encrypted certificate, and sending the encrypted certificate to the terminal device;
signing a second public key of the authentication server based on the third private key to generate a signed certificate; and sending the signed certificate to the terminal device; and
sending the public key certificate to the internet of things platform, so that the internet of things platform verifies validity of the encrypted certificate and the signed certificate from the terminal device based on the public key certificate.

14. The certificate issuance method of claim 13, further comprising:
encrypting a second private key to generate a private key ciphertext, and sending the private key ciphertext to the terminal device, so that the terminal device decrypts the private key ciphertext to obtain the second private key,
wherein the second private key is matched in pair with the second public key.

15. The certificate issuance method of claim 13, further comprising:
signing, in response to a fourth public key sent from the internet of things platform, the fourth public key based on the third private key to generate a platform certificate; and
sending the platform certificate to the terminal device.

16-19. (canceled)

20. An electronic device, comprising:
one or more processors; and
a storage device having one or more programs stored thereon, which when executed by the one or more processors, cause the one or more processors to implement the method of claim 1.

21. A computer-readable medium storing computer programs which, when executed by a processor, cause the processor to perform the method of claim 1.
